(19) United States
(12) Patent Application Publication
(10) Pub. No.: US 2016/0218546 A1
(43) Pub. Date: Jul. 28, 2016

(54) PROVIDING FEEDBACK BASED ON AN ELECTRONIC DEVICE PLACED ON A WIRELESS CHARGING DEVICE

(71) Applicants: Jeffrey Mark Schroeder, Rochester Hills, MI (US); Dinu Petre Madau, Canton, MI (US); Gary Edward Zack, Novi, MI (US)

(72) Inventors: Jeffrey Mark Schroeder, Rochester Hills, MI (US); Dinu Petre Madau, Canton, MI (US); Gary Edward Zack, Novi, MI (US)

(21) Appl. No.: 14/603,089

(22) Filed: Jan. 22, 2015

(51) Int. Cl. H02J 7/02

(52) U.S. Cl. CPC H02J 7/025

(57) ABSTRACT

A system, method and device for providing feedback based on an electronic device placed on a wireless charging device are provided. The system includes a device detector to receive an indication that a device is on the wireless charging device; a displacement detector to initiate a strength measurer to operate; the strength measurer to receive a strength indication of wireless charging from the wireless charging device independent of the electronic device; and a communicator to communicate an indication of the measured strength indication to an output device.

### CROSS-REFERENCE TO RELATED APPLICATION

This application is related to U.S. patent application Ser. No. ______, filed on ______, having attorney docket number 46107-02150(V214-0028), which is assigned to the same assignee as the current application, and all of which are incorporated by reference in its entirety as if fully set forth herein.

### BACKGROUND

Mobile electronics and devices are becoming increasingly popular. Often times, the mobile device includes an energy storage device, and employs the power in the energy storage device to operate the functionality associated with the mobile device. The mobile device may be a smart phone, a tablet, a laptop, or the like.

In order to charge the mobile device, a wired power charging system has been conventionally provided. An operator of the mobile device may connect the mobile device to a charging source (for example, a wall outlet or a vehicle electricity adapter), and wait for the device to become charged fully, or charged at a rate greater than an initial amount. The connection may be accomplished via a wire, or a socket associated with the mobile device that allows a user to plug in the mobile device into a charging source.

In recent years, the concept of wired charging has been replaced or augmented by wireless charging. The early implementations of wireless charging employed a coil that transmitted wireless energy to a mobile device. The mobile device would be equipped with a technique to receive the wireless energy, and translate the wireless energy to usable and storable power.

In this implementation, a singular coil is provided. Thus, an implementer of this sort of wireless charging may provide various indicia that serves to guide a user of a location or context of where to place the mobile device. In this way, the user is effectively guided in placing the mobile device in an area that optimizes and ensures wireless charging efficiency.

Recently, a plethora of mobile devices have been released. In other cases, a mobile device operator may affix a case or add-on that allows wireless charging to be available. The various mobile devices each have different sizes and charging capabilities. Accordingly, the single coil system may not effectively serve the wireless charging demands of a user. In some cases, the mobile devices are incorporated with wireless charging abilities.

To counter this concern, a wireless surface or sheet is provided. Accordingly, a user may place their mobile device on the wireless surface or sheet, and in response to this action, initiate a charging of the wireless device. Thus, a user may not be prompted to place the device in specific location.

In order to maximize or improve wireless charging, the mobile device receiving coil (“RX coil”) should be aligned with the wireless charging system's transmitter coil (“TX coil”). The closer to alignment of the RX coil and the TX coil leads to more efficient charging (i.e. a faster charging process).

If the mobile device is not aligned, certain problems with the wireless charging may occur. In some cases, the charging may be ineffective or at a rate slow enough to frustrate a mobile device's owner. Additionally, due to the additional power required to efficiently provide wireless charging, the mobile device may overheat and the mobile device may reach a temperature that causes failure of a battery or the mobile device's circuitry.

To remedy this, some wireless charging pads incorporate alignment aids. An alignment aid is indicia to indicate a location to place the mobile device to accomplish efficient or optimal wireless charging. Thus, a mobile device's operator is guided to place a mobile device onto the alignment aid, and accordingly, efficient wireless charging is achieved.

However, this solution has several problems. Primarily, each mobile device may not be the same size, and even if the mobile devices are the same size, the location of where the RX coil is for each device may not be the same. Thus, an alignment aid may be effective for one or some mobile devices, but ineffective for all.

Another solution proposed is an application on the mobile device itself. Thus, if the mobile device incorporates a display screen, the mobile device may display how efficient the charging. This solution may provide several challenges as well. For example, the mobile device needs to be on (and operational). Further, the mobile device may need to be in communication with a TX coil in order to determine whether optimal charging being achieved.

### SUMMARY

A system and method for providing feedback based on an electronic device placed on a wireless charging device are provided. The system includes a device detector to receive an indication that a device is on the wireless charging device; a displacement detector to initiate a strength measurer to operate; the strength measurer to receive a strength indication of wireless charging from the wireless charging device independent of the electronic device; and a communicator to communicate an indication of the measured strength indication to an output device.

### DESCRIPTION OF THE DRAWINGS

The detailed description refers to the following drawings, in which like numerals refer to like items, and in which:

FIG. 1 is a block diagram illustrating an example computer.

FIGS. 2(a) and (b) illustrate an example wireless charging device for implementation with the aspects disclosed herein.

FIG. 3 illustrates an example system for providing feedback based on an electronic device placed on a wireless charging device.

FIG. 4 illustrates an example of employing a combination of a current, voltage, and frequency to determine whether a transmitter (TX) coil is transferring energy at an efficient amount.

FIG. 5 illustrates an example employing a coil peak voltage measurement to determine whether the TX coil is transferring energy at an efficient amount.

FIGS. 6(a)-(c) illustrate examples of GUI elements employable by system for display on a display.

FIG. 7 illustrates an example method for providing feedback based on an electronic device placed on a wireless charging device.

FIGS. 8(a) and (b) illustrate an example of an implementation of system of FIG. 3.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Providing wireless charging to a user allows a mobile device to be effectively charged while avoiding the hassle of employing wires and other intermediary connecting techniques. In one example of wireless charging, a metal coil is employed to wirelessly generate energy, and transmit the energy over a space. A mobile device may be equipped with a receiver that receives the wireless energy, and translates the received wireless energy in power that may be employed to operate the device. A mobile device (or electronic device) may be any device in which charging is required, such as a smart phone, a tablet, a wearable watch, and the like.

As explained in the Background section, wireless charging surfaces may be implemented and provided to the user. The wireless charging surface may have one or multiple coils to act as a TX coil(s).

Depending on the placement of the mobile device onto the wireless surface, the charging of an individual coil may be improved or worsened. The ability to charge a mobile device from a single coil is dependent on various factors, one of which is the location of the TX coil relative to the device's RX coil being charged.

Thus, a placement that is optimal, i.e. where the efficiency of delivering energy from a TX coil to a RX coil, allows a mobile device to be charged in the fastest and safest manner. However, because a wireless charging system may be implemented in a manner where the TX coil is obscured from view, being cognizant of an optimal placement may not be feasible.

Disclosed herein are systems, methods, and wireless charging devices for providing feedback based on an electronic device placed on a wireless charging device. A wireless charging device includes a surface attached to a wireless charging system that allows for a placement of an electronic device for wirelessly charging the electronic device.

The wireless charging device may contain a TX coil that inductively transfers energy to an RX coil attached or affixed to the electronic device. The wireless charging device may be employed in various contexts, for example a vehicle, and thus, for aesthetic reasons the TX coil may be obscured from view. However, by employing the aspects disclosed herein, an operator of a mobile device may determine a location to place an electronic device with an improved charging efficiency.

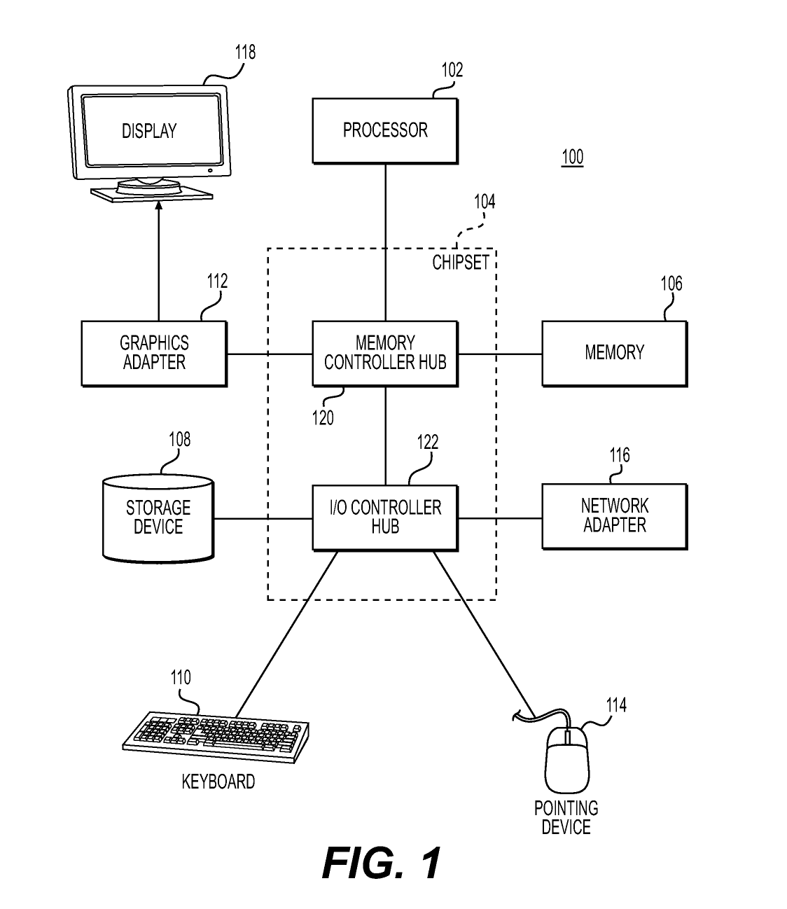

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network.

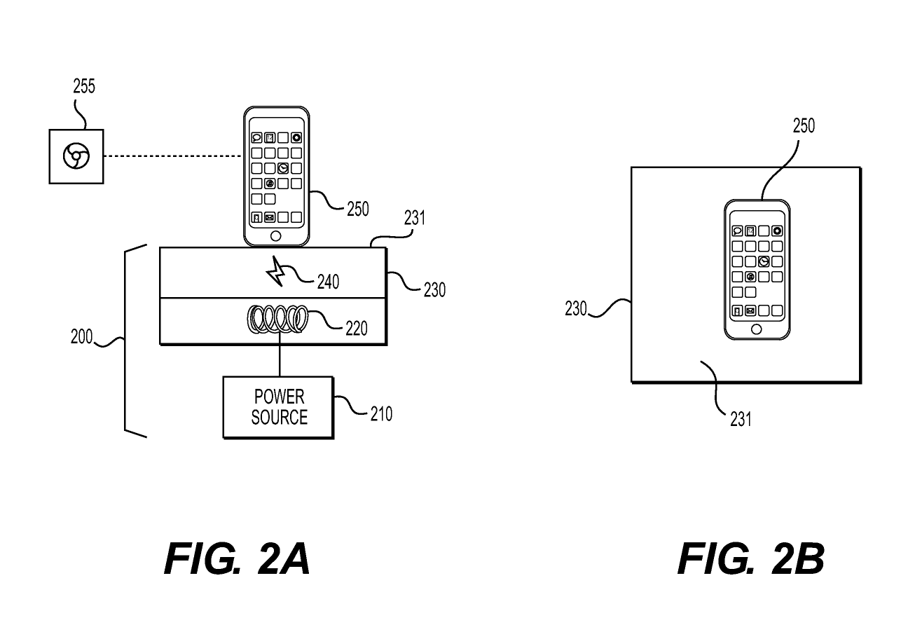

FIGS. 2(a) and (b) illustrate an example wireless charging device 200 for implementation with the aspects disclosed herein. Referring to FIG. 2(a), a cross-sectional view of the wireless charging device 200 is shown. Referring to FIG. 2(b), a top-view of the wireless charging device 200 is shown.

In FIGS. 2(a) and 2(b), an electronic device 250 is placed onto a wireless charging device 200. The electronic device 250 may be any portable electronic device that allows a storage unit to be charged via a wireless energy transfer 240.

The wireless charging device 200 shown in FIG. 2(a) is exemplary, with other configurations of known wireless charging devices being capable of replacing the wireless charging device 200 shown. The wireless charging device 200 includes a surface layer 230 (with a top surface 231). The electronic device 250 is disposed onto the top surface 231, and may be in direct contact with the top surface 231.

Also shown is a coil 220. The coil 220 allows for the wireless transfer of energy 240 to an RX coil 255. The RX coil 255 is affixed to the electronic device 250, and may be configured to receive energy 240, and transfer the energy into power usable by the electronic device 250. The coil 220 may receive power from a power source 210. The power source 210 may be a battery, car engine, or any source of energy transferrable via wireless propagation.

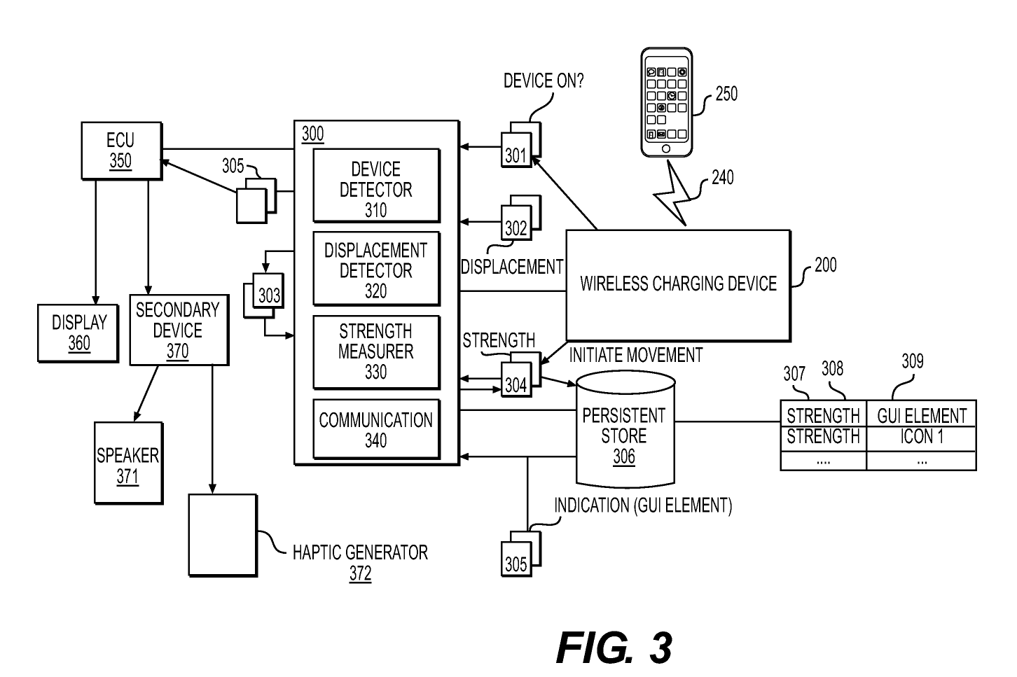

FIG. 3 illustrates an example system 300 for providing feedback based on an electronic device 250 placed on a wireless charging device 200. The system 300 includes a device detector 310, a displacement detector 320, a strength measurer 330, and a communicator 340. The system 300 may be embedded onto a processing device, such as computer 100 described above.

Referring to FIG. 3, the system 300 is shown coupled to an electronic control unit (ECU) 350. The ECU 350 may be any sort of processing or control circuity configured to receive and send information to the system 300, and other componentry (such as display 360 or a second device 370). For example, in response to system 300 being implemented in a vehicle, the ECU 350 may be a center console.

The ECU 350 is configured to send information to a display 360. The information sent to the display 360 may be data that is rendered into graphical user interface (GUI) elements. The GUI elements may represent various states and conditions associated with system 300 or other componentry associated with ECU 350.

Also shown is a secondary device 370. The secondary device 370 may be a non-display output device associated with ECU 350. Thus, in certain implementations of system 300, the implementer may configure information to be conveyed in a non-display fashion. For example, the non-display output device may be an audio output, a haptic generator, or the like. An implementer of system 300 may incorporate any combinations of display 360 and secondary device 370 based on an implementer's preference.

As shown in FIG. 3, an electronic device 250 is in a process of being charged by the wireless charging device 200, via energy 240. An operator of the electronic device 250 may place the electronic device in various locations of a top surface 231, and thus, achieve different charging efficiencies.

The device detector 310 receives an indication that an electronic device 250 is on a wireless charging device 200, and receiving energy 240 via a wireless propagation. The wireless charging device 200 may transmit information or data (via data file ‘device on? 301) to the system 300. The device detector 310 may be configured to re-check whether the device is still on after a predetermined time period has elapsed.

The displacement detector 320 detects whether the electronic device 250 is displaced. Displacement may occur intentionally or unintentionally. For example, the electronic device 250′s operator may elect to move the electronic device 250 from a first location to a second location on surface 231. In another example, the electronic device 250 may move due to no interaction from an operator at all. For example, if the wireless charging device 200 is implemented in a vehicle, the movement of the vehicle may cause the electronic device 250 to be displaced.

In one example, the displacement detector 320 may be coupled to sensors that detect movement of the electronic device 250. The sensors may be coupled with system 300, or built into the wireless charging device 200. The sensors may transmit displacement data 302 to the system 300, thereby indicating movement of the electronic device 250.

In another example, the displacement detector 320, and system 300, may omit sensors all together. In another implementation of system 300, the displacement detector may be configured to initiate a re-check after a predetermined time period has elapsed. If the displacement detector 320 initiates a re-check (either by detecting a displacement, or by waiting for a predetermined time period to elapse), the system 300 is instructed to initiate the strength measurer 330.

The strength measurer 330 measures the efficiency of the energy transfer between the electronic device 250 and the wireless charging device 200. The strength measurer 330 may be configured to include a measuring module capable of determining the strength (or efficiency) of energy transfer. In another example, the strength measurer 330 may communicate an initiation signal 303 to a wireless charging module 200, or another system or device for measuring charging efficiency. In either case, a strength data 304 is received by system 300.

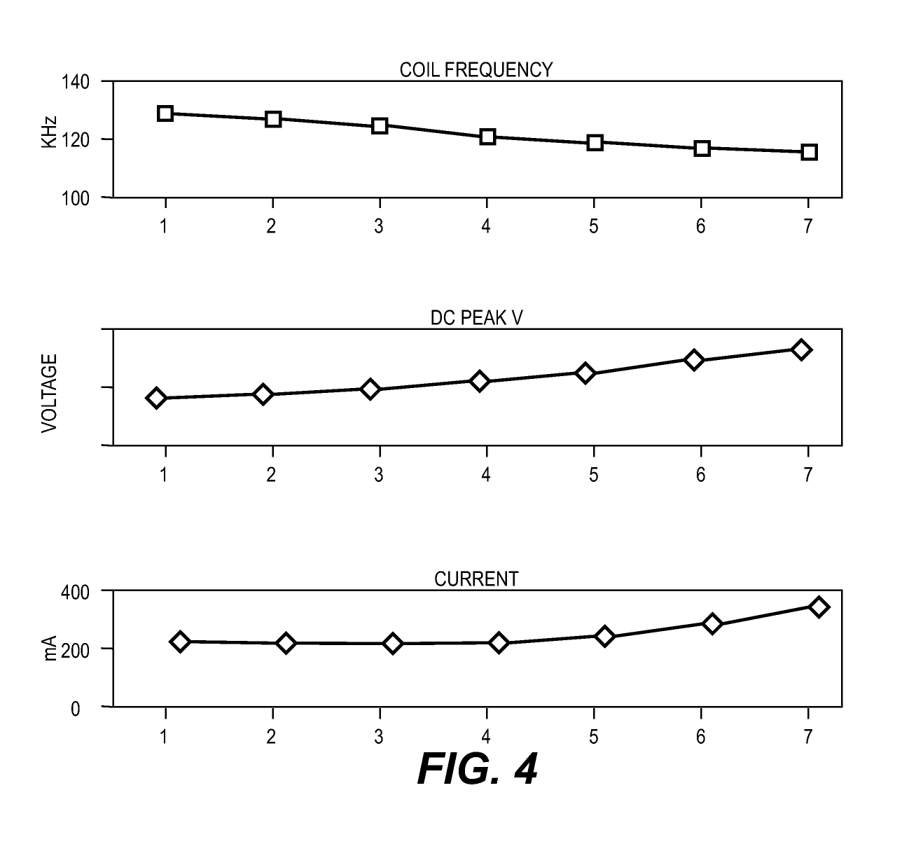

Determining the strength/efficiency of wireless transfer may be accomplished by numerous techniques. FIG. 4 illustrates an example of employing a combination of a current, voltage, and frequency to determine whether the TX coil 220 is transferring energy at an efficient amount. The various parameters shown in FIG. 4 may be correlated to a predefined efficiency amount.

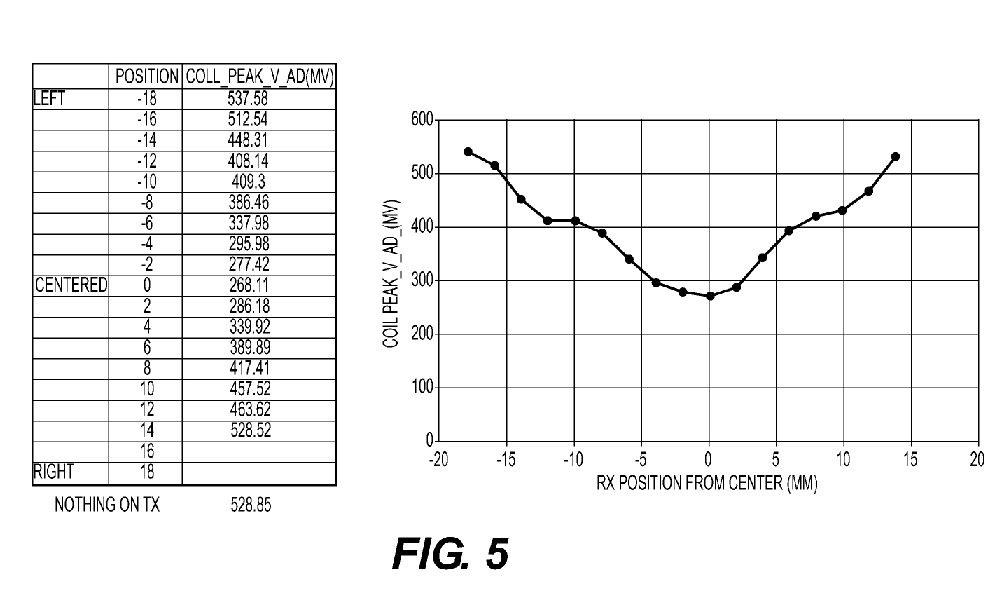

FIG. 5 illustrates an example employing a coil peak voltage measurement to determine whether the TX coil 220 is transferring energy at an efficient amount. Once again, the various coil peak voltage amounts may be correlated with a predetermined charging efficiency.

The parameters employed in FIGS. 4 and 5 are merely exemplary. In both cases, the measured parameters rely only on information obtained via the wireless charging device 200 (i.e. independent of the electronic device 250 or an RX coil 255). Thus, other techniques to determine signal strength from only a wireless charging device 200 may be employed.

Once the strength 304 is obtained is obtained by one of the above-enumerated techniques (or another acceptable technique), the system 200 retrieves an indication (or GUI element) 305 associated with the strength. In one example, the indication 305 may be communicated to the ECU 350, and a GUI element associated with the indication may be determined by the ECU 350 (either automatically, or by user selection). In another situation, the GUI element may be selected based on a lookup table 307 (stored in a persistent store 306) provided with the system 300.

The lookup table 307 may have two fields, a strength field 308 and a GUI element 309. Thus, each strength 304 amount (or ranges of amount) may be correlated with a specific GUI element.

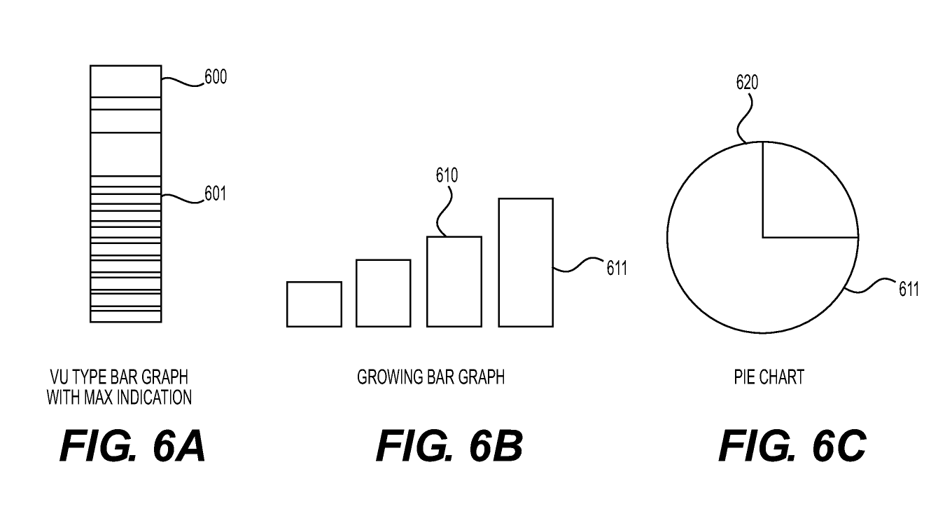

FIGS. 6(a)-(c) illustrate examples of GUI elements 305 employable by system 300 for display on a display 360. Referring to FIG. 6(a), a growing bar 600 is shown. Referring to FIG. 6(b), a bar graph 610 is shown. Referring to FIG. 6(c), a pie chart 620 is shown.

In all three graphical representations (600, 610, and 620), the GUI element 305 is rendered onto the display to show a representation of the signal strength 304. The GUI element shown on the display 360 represents an amount of the signal strength 304, and accordingly, may alter as the electronic device 250 is displaced on the surface 231.

For example, in the growing bar 600, the indicia for power 601 shown in the growing bar may increase as the electronic device 250 is moved to position where the strength 304 is at a higher or optimal rate.

Accordingly, in the bar graph 610 example, indicia 611 may increase as the electronic device 250 is moved to position where the strength 304 is at a higher or optimal rate. And following suit, in the pie chart 620 example, the portion 621 of the pie chart 620 may increase as the strength 304 increases due to movement on the surface 231.

The communicator 340 may communicate the indication (or GUI element) 305 to the ECU 350. The ECU 350 may render a GUI element, or propagate a retrieved GUI element to the display 360. As explained above, ECU 350 may output the indication 305 in a non-displayable manner via a secondary device 370 (for example, a speaker 371 or a haptic generator 372).

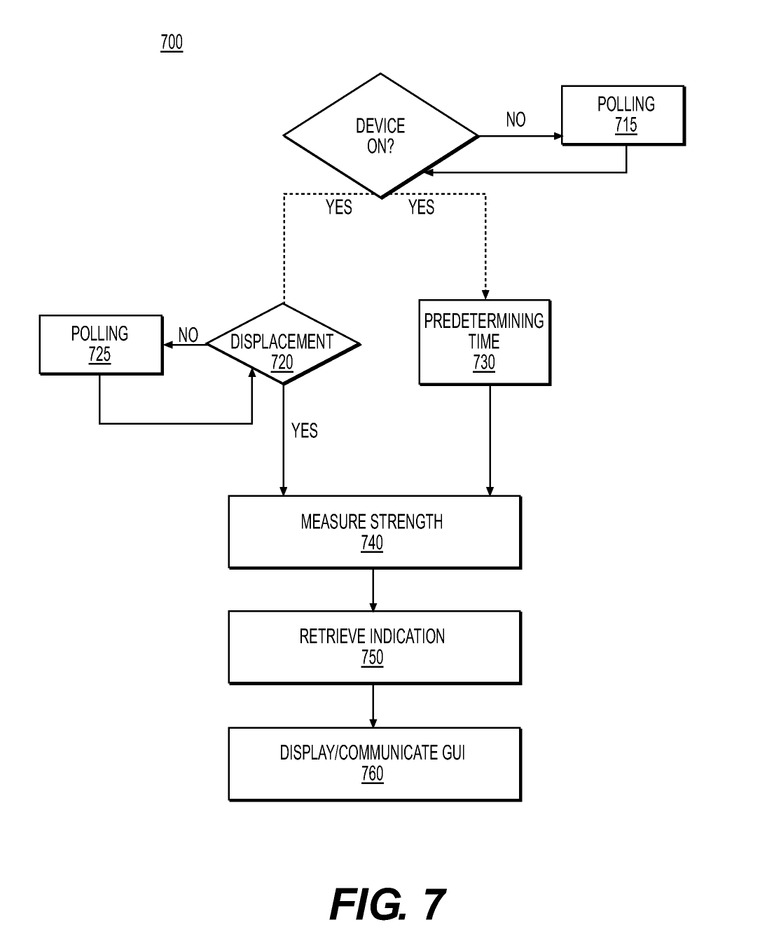

FIG. 7 illustrates an example method 700 for providing feedback based on an electronic device placed on a wireless charging device. The method 700 may be performed on a processing device, such as computer 100.

In operation 710, a detection of a device being on a wireless charging device is made. The detection may be made via the wireless charging device itself, or by polling 715 the wireless charging device. If no, the polling 715 may occur at predetermined intervals (based on time or events). If yes, the method 700 proceeds to operation 720 or 730 (depending on the implementation).

In operation 720, a determination is made as to whether a displacement is detected. If no, the method 700 performs another polling operation 725. Thus, the method 700 remains at operation 720 until a displacement is detected. The polling 725 may initiate the determination in operation 720 after a predetermined time has elapsed. If the displacement is detected, the method 700 may proceed to operation 740.

In operation 730, which is presented as an alternate route in method 700, after a predetermined time, the method 700 may proceed to operation 740.

In operation 740, a strength associated with the wireless charging is measured. The strength measurement may be in accordance with any of the above-enumerated techniques. The strength measurement records an efficiency associated with wireless transfer of energy to an electronic device. The strength measurement performed in operation 740 only employs information ascertained from a transmitter. Thus, connection to a RX coil, or the electronic device, is obviated.

In operation 750, an indication associated with the strength is retrieved. As explained above in regards to system 300, the indication may be data associated with how efficient the charging is. For example, the strength may be associated with a percentage of charging (relative to an optimal amount). The indication or percentage may be translated to a predetermined GUI element, such as those shown in FIGS. 6(a)-(c).

In operation 760, the GUI element may be displayed. In another embodiment of method 700, the GUI element may be communicated to another device (such as an ECU) to render onto a display.

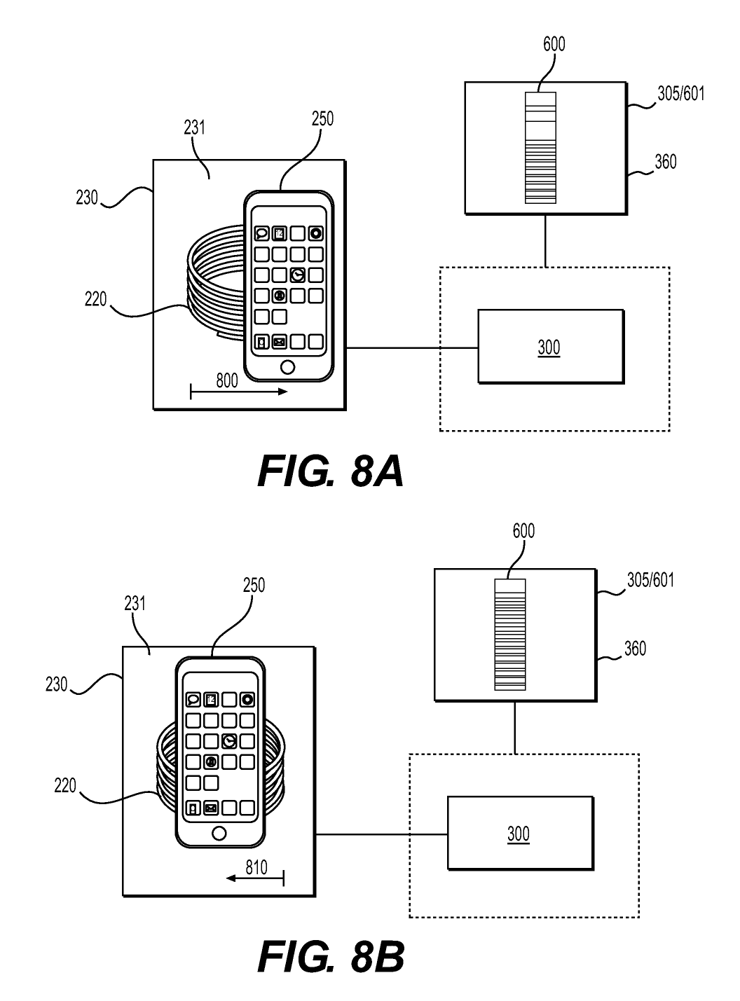

FIGS. 8(a) and (b) illustrate an example of an implementation of system 300. The implementation may be in any location suitable for providing wireless charging, for example, a vehicle.

Shown in FIGS. 8(a) and (b) is a wireless charging device 200 (with the pad 230 and surface 231 being shown), coupled to system 300. System 300 is coupled to a display 360. The display 360 is configured to display a growing bar 600, with GUI element 305 (or indicia 601). The GUI element 305 represents the percentage of efficiency associated with wireless power transfer between a TX coil 220 and a RX coil 255. In the example shown in FIGS. 8(a) and (b), the TX coil 220 is shown. However, this is done merely for exemplary purposes. In many implementations, the TX coil 220 will be obscured by the wireless charging surface 230.

In FIG. 8(a), the TX coil 220 and RX coil 255 are shown to be a distance of about 800 apart. This reflects into an efficiency of 50% (an exemplary amount). Thus, employing the aspects disclosed herein, the system 300 renders the GUI element 305 with power level 601 shown in FIG. 8(a) on display 360. As shown, the graph 600 is approximately half filled.

In FIG. 8(b), a movement of the electronic device 250 of about 810 has now caused the RX coil 255 and the TX coil 220 to overlap more than what is shown in FIG. 8(a). Thus, the efficiency of charging may be substantially more. This is reflected in the graph 600 in display 360 being substantially filled.

Thus, an electronic device 250′s operator may employ the aspects disclosed herein to manually move the electronic device 250 on a wireless charging surface 230, to ensure optimal or improved charging.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for providing feedback based on an electronic device placed on a wireless charging device, comprising:
a data store comprising a computer readable medium storing a program of instructions for the providing of the feedback;
a processor that executes the program of instructions;
a device detector to receive an indication that a device is on the wireless charging device;
a displacement detector to initiate a strength measurer to operate;
the strength measurer to receive a strength indication of wireless charging from the wireless charging device independent of the electronic device; and
a communicator to communicate an indication of the measured strength indication to an output device.

2. The system according to claim 1, wherein the strength measurer employs a frequency component of a TX coil embedded in the wireless charging device.

3. The system according to claim 1, wherein the strength measurer employs a voltage component of a TX coil embedded in the wireless charging device.

4. The system according to claim 1, wherein the strength measurer employs a current component of a TX coil embedded in the wireless charging device.

5. The system according to claim 1, wherein the strength measurer employs a coil peak voltage component of a TX coil embedded in the wireless charging device.

6. The system according to claim 1, the indication is correlated to a GUI element.

7. The system according to claim 1, wherein the communicated indication is rendered into a GUI element via a display device.

8. The system according to claim 6, wherein the GUI element indicates a percentage of efficiency associated with wireless charging relative to a predetermined optimal efficiency.

9. The system according to claim 1, wherein the displacement detector initiates the strength measurer based on a detected movement of the electronic device on the wireless charging device.

10. The system according to claim 1, wherein the displacement detector initiates the strength measurer based on an elapse of a predetermined time.

11. A wireless charging device, comprising:
a wireless charging surface configured to allow placement of an electronic device onto the wireless charging surface; and
an interface bus that allows a connection to a feedback device,
wherein the feedback device determines an efficiency of charging associated with the wireless charging surface and the electronic device based on monitoring only a TX coil associated with the wireless charging device.

12. The device according to claim 11, wherein the feedback device is coupled to a display device, and the display device displays the efficiency.

13. The device according to claim 12, wherein the display of efficiency is graphical.
